(19) United States
(12) Patent Application Publication
(10) Pub. No.: US 2015/0317745 A1
(43) Pub. Date: Nov. 5, 2015

(54) SYSTEMS AND METHODS FOR INSURANCE PRODUCT PRICING AND SAFETY PROGRAM MANAGEMENT

(71) Applicant: The Travelers Indemnity Company, Hartford, CT (US)

(72) Inventors: Dean M. Collins, Manchester, CT (US); Gregory L. Cote, Granby, CT (US); Christopher M. Hayes, Wethersfield, CT (US); Beth S. Tirone, Hebron, CT (US)

(21) Appl. No.: 14/796,013

(22) Filed: Jul. 10, 2015

Related U.S. Application Data
(62) Division of application No. 13/225,366, filed on Sep. 2, 2011.

(51) Int. Cl. G06Q 40/08; G06Q 30/02

(52) U.S. Cl. CPC G06Q 40/08; G06Q 30/0206

(57) ABSTRACT

Systems, apparatus, interfaces, methods, and articles of manufacture that provide for insurance product pricing and safety program management such as, for example, utilizing vehicle telematics to determine product premiums, surcharges, and/or discounts and providing safety program management advice regarding how product pricing may be changed.

### CROSS-REFERENCE TO RELATED APPLICATIONS

This application claims benefit and priority under 35 U.S.C. §120 to, and is a Divisional of, U.S. patent application Ser. No. 13/225,366 filed on Sep. 2, 2011 in the name of Collins et al. and titled “SYSTEMS AND METHODS FOR INSURANCE PRODUCT PRICING AND SAFETY PROGRAM MANAGEMENT”, which is incorporated by reference herein in its entirety.

### BACKGROUND OF THE INVENTION

Insurance product underwriting decisions are determined by application of multiple information parameters, often gathered from a variety of sources. Such sources may often include an application for an insurance product (e.g., information parameters provided by a potential customer), third-party data sources (e.g., credit rating agencies and/or Department of Motor Vehicle (DMV) records), and more recently with respect to insurance products such as commercial auto and/or fleet insurance products, vehicle telematic devices. As with personal auto insurance products, commercial and/or fleet insurance products have begun to utilize vehicle telematics to make product pricing decisions based on driver performance. Such vehicle telematic utilization methodologies, however, do not necessarily provide an accurate measure of fleet safety and/or risk, especially for fleets with high driver and/or vehicle turnover rates.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is flow diagram of a method according to some embodiments;

FIG. 4 is flow diagram of a method according to some embodiments;

FIG. 5 is flow diagram of a method according to some embodiments;

FIG. 6 is a block diagram of an apparatus according to some embodiments;

FIG. 7A and FIG. 7B are perspective diagrams of example data storage devices according to some embodiments; and

FIG. 8 is an example interface according to some embodiments.

### DETAILED DESCRIPTION

Embodiments described herein are descriptive of systems, apparatus, interfaces, methods, and articles of manufacture for insurance product pricing and safety program management, such as, for example, utilizing vehicle telematics to determine product pricing and/or providing safety program management advice and/or guidance regarding how product pricing may be changed. In some embodiments, for example, the process of underwriting (e.g., quoting and/or selling) various products may be enhanced by an evaluation of a customer's (or potential customer's; as utilized herein a customer may comprise a potential customer—in general and/or with respect to a specific product offering) safety program (e.g., a set of procedures, routines, rules, specified actions, guidelines, etc.), such as by utilization of vehicle telematic data associated therewith. According to some embodiments, an interface for safety program and/or vehicle telematic feedback may be provided to assist the customer in making improvements to a safety program. In some embodiments, other information and/or metrics may also or alternatively be utilized to evaluate, manage, and/or affect fleet safety programs and/or to price, adjust, and/or discount insurance products.

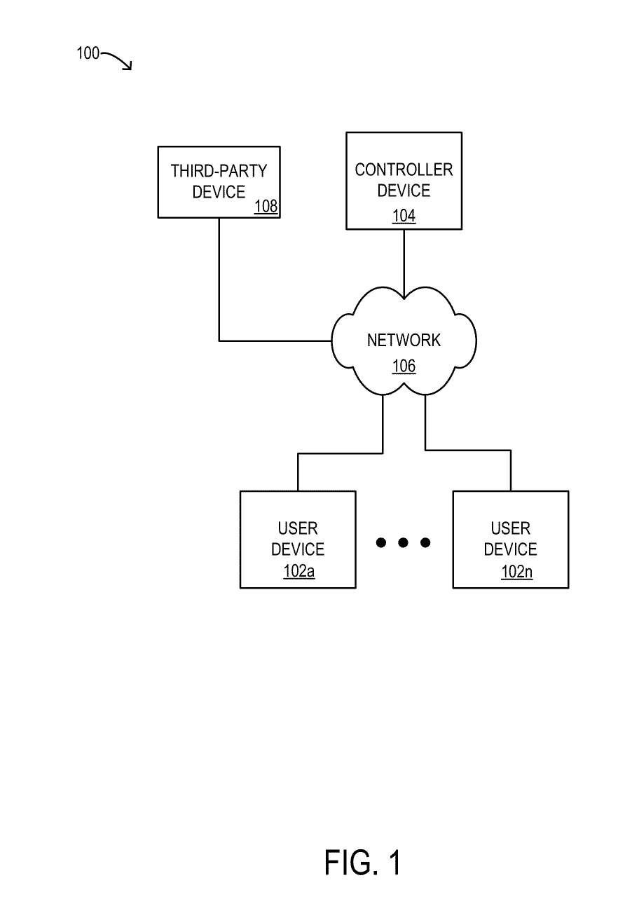

Referring first to FIG. 1, for example, a block diagram of a system 100 according to some embodiments is shown. In some embodiments, the system 100 may comprise a plurality of user devices 102a-n, a controller device 104, a network 106, and/or a third-party device 108. As depicted in FIG. 1, any or all of the devices 102a-n, 104, 108 (or any combinations thereof) may be in communication via the network 106. In some embodiments, the system 100 may be utilized to provide one or more users (not explicitly shown) of the user devices 102a-n with insurance product pricing and/or safety program management information. The controller device 104 may, for example, interface with one or more of the user devices 102a-n and/or the third-party device 108 to provide insurance product price quotes based on vehicle telematics and/or based on a safety program evaluation (e.g., utilizing vehicle telematics data), and/or may provide safety program feedback and/or coaching (as described herein). As utilized herein, an “insurance product” may comprise any type, quantity, and/or configuration of insurance product such as, but not limited to, a commercial insurance product, a business insurance product, and/or a personal insurance product.

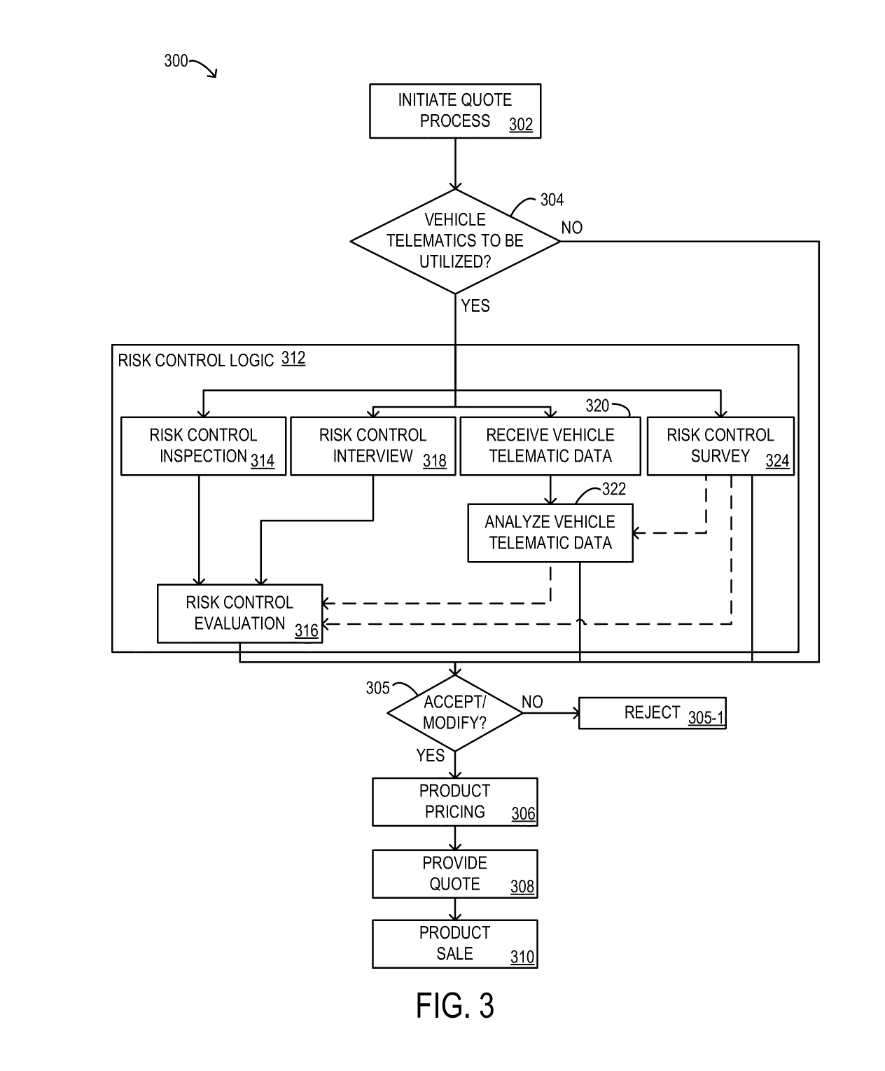

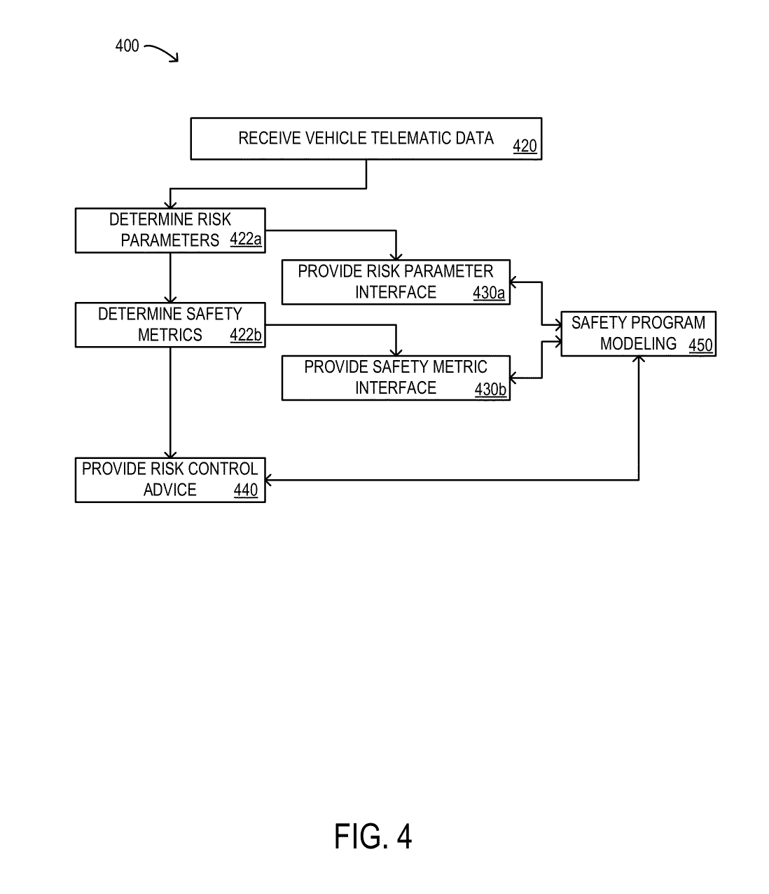

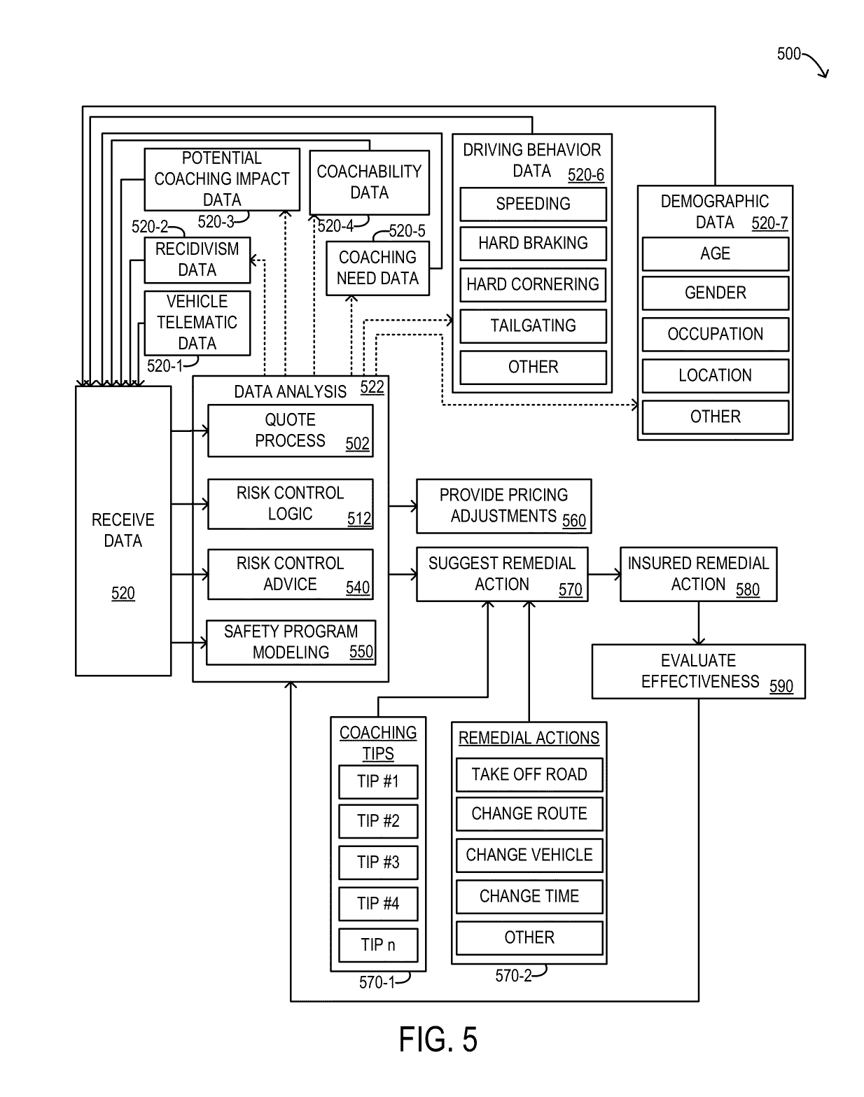

Fewer or more components 102a-n, 104, 106, 108 and/or various configurations of the depicted components 102a-n, 104, 106, 108 may be included in the system 100 without deviating from the scope of embodiments described herein. In some embodiments, the components 102a-n, 104, 106, 108 may be similar in configuration and/or functionality to similarly named and/or numbered components as described herein. In some embodiments, the system 100 (and/or portion thereof) may comprise an underwriting program and/or platform programmed and/or otherwise configured to execute, conduct, and/or facilitate any of the various methods 300, 400, 500 of FIG. 3, FIG. 4, and/or FIG. 5 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more PC devices, computer workstations (e.g., underwriter workstations), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as underwriters, account managers, agents/brokers, customer service representatives, and/or underwriting product customers.

According to some embodiments, the user devices 102a-n may communicate with the controller device 104 via the network 106, such as to conduct underwriting inquiries and/or processes and/or to manage a safety program, as described herein. In some embodiments, the user devices 102a-n may interface with the controller device 104 to effectuate communications (direct or indirect) with one or more other user devices 102a-n (such communication not explicitly shown in FIG. 1), such as may be operated by other users. In some embodiments, the user devices 102a-n may interface with the controller device 104 to effectuate communications (direct or indirect) with the third-party device 108 (such communication also not explicitly shown in FIG. 1).

In some embodiments, any or all of the user devices 102a-n may comprise a vehicle, an on-board computer such as an Electronic Control Module (ECM), Engine Control Unit (ECU), and/or other vehicle processing device and/or microprocessor, one or more sensor devices (e.g., an accelerometer, location sensor, and/or tire pressure sensor), and/or a vehicle telematics device. The user devices 102a-n may, for example, comprise vehicle telematic devices of a fleet of vehicles for which an insurance product is desired (and/or for which an insurance policy already exists). According to some embodiments, the user devices 102a-n may provide telematic data to the controller device 104 (and/or to the third-party device 108).

According to some embodiments, the controller device 104 may comprise an electronic and/or computerized controller device such as a computer server communicatively coupled to interface with the user devices 102a-n and/or the third-party device 108 (directly and/or indirectly). The controller device 104 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 104 may be located remote from one or more of the user devices 102a-n and/or the third-party device 108. The controller device 104 may also or alternatively comprise a plurality of electronic processing devices located at one or more various sites and/or locations.

In some embodiments, the controller device 104 may store and/or execute specially programmed instructions to operate in accordance with embodiments described herein. The controller device 104 may, for example, execute one or more programs that facilitate the underwriting process (e.g., based on vehicle telematics) and/or that provide feedback and/or guidance to safety program managers. According to some embodiments, the controller device 104 may comprise a computerized processing device such as a PC, laptop computer, computer server, and/or other electronic device to manage and/or facilitate transactions and/or communications regarding the user devices 102a-n (e.g., in an attempt to increase the efficiency and/or effectiveness of underwriting). An underwriter (and/or customer, client, or company) may, for example, utilize the controller device 104 to (i) price and/or underwrite one or more products, such as insurance, indemnity, and/or surety products, (ii) determine and/or be provided with vehicle telematic data as described herein, (iii) determine and/or be provided with safety program information as described herein, and/or (iv) provide an interface via which a safety program manager (and/or other user) may manage and/or otherwise interact with the parameters and/or procedures of a safety program based on vehicle telematics (e.g., in accordance with embodiments described herein).

The network 106 may, according to some embodiments, comprise a LAN (wireless and/or wired), cellular telephone, Bluetooth®, and/or RF network with communication links between the controller device 104, the user devices 102a-n, and/or the third-party device 108. In some embodiments, the network 106 may comprise direct communications links between any or all of the components 102a-n, 104, 108 of the system 100. The user devices 102a-n may, for example, be directly interfaced or connected to one or more of the controller device 104 and/or the third-party device 108 via one or more wires, cables, wireless links, and/or other network components, such network components (e.g., communication links) comprising portions of the network 106. In some embodiments, the network 106 may comprise one or many other links or network components other than those depicted in FIG. 1. The user devices 102a-n may, for example, be connected to the controller device 104 via various cell towers, routers, repeaters, ports, switches, and/or other network components that comprise the Internet and/or a cellular telephone (and/or Public Switched Telephone Network (PSTN)) network, and which comprise portions of the network 106.

While the network 106 is depicted in FIG. 1 as a single object, the network 106 may comprise any number, type, and/or configuration of networks that is or becomes known or practicable. According to some embodiments, the network 106 may comprise a conglomeration of different sub-networks and/or network components interconnected, directly or indirectly, by the components 102a-n, 104, 108 of the system 100. The network 106 may comprise one or more cellular telephone networks with communication links between the user devices 102a-n and the controller device 104, for example, and/or may comprise the Internet, with communication links between the controller device 104 and the third-party device 108, for example.

The third-party device 108, in some embodiments, may comprise any type or configuration of a computerized processing device such as a PC, laptop computer, computer server, database system, and/or other electronic device, devices, or any combination thereof. In some embodiments, the third-party device 108 may be owned and/or operated by a third-party (i.e., an entity different than any entity owning and/or operating either the user devices 102a-n or the controller device 104). The third-party device 108 may, for example, be owned and/or operated by a vehicle telematic data and/or data service provider such as NetworkFleet, Inc. of San Diego, Calif. In some embodiments, the third-party device 108 may supply and/or provide data such as business data, consumer data, credit data, public records, and/or vehicle telematics data to the controller device 104 and/or the user devices 102a-n. In some embodiments, the third-party device 108 may comprise a plurality of devices (e.g., may comprise a plurality of vehicle telematics devices) and/or may be associated with a plurality of third-party entities.

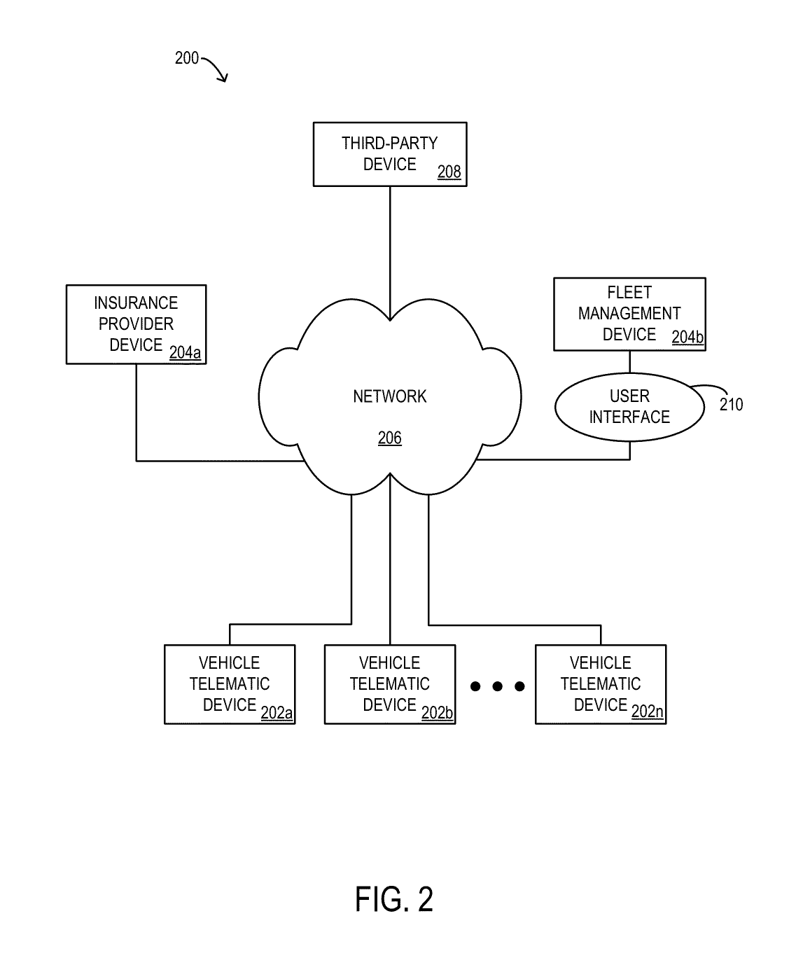

Turning to FIG. 2, a block diagram of a system 200 according to some embodiments is shown. In some embodiments, the system 200 may conduct and/or facilitate insurance product pricing (e.g., initial quotation, discounting, adjusting, and/or re-pricing) and/or facilitate safety program management and/or feedback, such as based on vehicle telematics. The system 200 may, for example, be similar in configuration and/or functionality to the system 100 of FIG. 1 herein. According to some embodiments, the system 200 may comprise a plurality of vehicle telematic devices 202a-n, one or more controller devices 204 (an insurance provider device 204a and/or a fleet management device 204b), a network 206, a third-party device 208, and/or a user interface 210.

Fewer or more components 202a-n, 204a-b, 206, 208, 210 and/or various configurations of the depicted components 202a-n, 204a-b, 206, 208, 210 may be included in the system 200 without deviating from the scope of embodiments described herein. In some embodiments, the components 202a-n, 204a-b, 206, 208, 210 may be similar in configuration and/or functionality to similarly named and/or numbered components as described herein. In some embodiments, the system 200 (and/or a portion thereof) may comprise an underwriting and/or fleet management program and/or platform programmed and/or otherwise configured to execute, conduct, and/or facilitate any of the various methods 300, 400, 500 of FIG. 3, FIG. 4, and/or FIG. 5 and/or portions or combinations thereof described herein.

In some embodiments, the vehicle telematic devices 202a-n may comprise any quantity, type, configuration, and/or combination of processing devices capable of sensing and/or providing vehicle data. The vehicle telematic devices 202a-n may, for example, comprise on-board vehicle processing devices such as an ECM and/or ECU device, one or more vehicle sensors (such as components of a Tire Pressure Monitoring System (TPMS) device), and/or vehicle communication devices such as receivers, transmitters, and/or transceivers. According to some embodiments, the vehicle telematic devices 202a-n may each comprise an ET-MTI (Mini-Telematics Interface) telematics device manufactured by EASE Telematics of Scott, Township, Pa. Such a device may connect to and/or be powered by the standard diagnostics port of a vehicle such as via an On-Board Diagnostic II (OBD II) diagnostic connector and/or support multiple communications types and/or protocols such as the Society of Automobile Engineers International (SAE) J1850 Pulse-Width Modulation (PWM), J1939 Heavy Duty (HD), and/or J1850 Variable Pulse Width (VPW) protocols, and/or the International Organization for Standardization (ISO) 9141-2, 14230 Keyword Protocol 2000 (KWP2000), and/or 15765 Controller-Area Network (CAN) protocols. In some embodiments, the vehicle telematic devices 202a-n may comprise electronic devices placed within a vehicle and/or placed to otherwise monitor a vehicle, without directly interfacing with on-board diagnostics and/or systems (e.g., a stand-alone accelerometer, a Global Positioning System (GPS), and/or a traffic camera). In some embodiments, the vehicle telematic devices 202a-n may sense vehicle data, store indications of the sensed data, analyze, aggregate, combine, parse, sort, rank, and/or otherwise process the sensed and/or stored data. The vehicle telematic devices 202a-n may, for example, provide raw or simple vehicle data to the insurance provider device 204a, fleet management device 204b, and/or third-party device 208, and/or may provide pre-processed results, statistics, calculations, scores, and/or other metrics and/or indications.

According to some embodiments, the insurance provider device 204a may comprise a computerized device operated by a user and/or insurance underwriter (not shown), such as an electronic device owned and/or operated by or on behalf of or in connection with an insurance entity. The insurance provider device 204a may comprise, for example, a server, program (e.g., a web browser plug-in), and/or application (e.g., an underwriting application) configured to facilitate the underwriting (or pricing) process. The insurance provider device 204a may, for example, provide underwriting services for insurance and/or other products, as exemplified by the methods 300, 500 (or portions thereof) of FIG. 3 and/or FIG. 5 herein (e.g., by communicating with the vehicle telematic devices 202a-n and/or via the user interface 210). According to some embodiments, the insurance provider device 204a may also or alternatively provide safety program management, guidance, counseling, and/or other facilitation services as exemplified by the methods 400, 500 (or portions thereof) of FIG. 4 and/or FIG. 5 herein (e.g., by communicating with the vehicle telematic devices 202a-n and/or via the user interface 210).

In some embodiments, the fleet management device 204b may comprise an electronic device owned and/or operated by or on behalf of or in connection with an insurance client such as a commercial vehicle fleet client. The fleet management device 204b may comprise, for example, a computer and/or server of a company that operates and/or owns or manages a fleet of insured (and/or otherwise underwritten) vehicles (not explicitly shown in FIG. 2). The fleet management device 204b may, in some embodiments, be utilized to manage a safety program such as a fleet vehicle and/or driver safety program, such as by communicating with the vehicle telematic devices 202a-n, the insurance provider device 204a, and/or the third-party device 208 (e.g., via the user interface 210). In some embodiments, the fleet management device 204b and the insurance provider device 204a may comprise the same device and/or devices. In the case that an insurance customer prices their own insurance policy online (e.g., via the user interface 210 and/or as the insurance provider device 204a), for example, the customer may utilize the same computing device and/or system to interact with the user interface 210 to manage a safety program of the customer (e.g., as the fleet management device 204b). Similarly, in the case that an insurance company both quotes and/or provides an insurance product (e.g., as the insurance provider device 204a) as well as offers safety program management, guidance, and/or feedback (e.g., as the fleet management device 204b), the same computer and/or computer system or other device or set of devices may be utilized to accomplish those tasks. In some embodiments, though different computers, computer systems, and/or devices may be utilized for insurance product pricing and safety program management, a single entity may effectuate both processes (e.g., one insurance agent/underwriter may price a policy via a first computer (e.g., the insurance provider device 204a), for example, while a second insurance company employee such as a Customer Service Representative (CSR) may provide safety program management services via a second computer (e.g., the fleet management device 204b)).

According to some embodiments, the fleet management device 204b may be utilized (e.g., by a user; not shown) to access the user interface 210. The user interface 210 may, for example, comprise a Graphical User Interface (GUI), such as a web page, form, and/or Application Program Interface (API) provided by (and/or otherwise associated with) the insurance provider device 204a and/or the third-party device 208. According to some embodiments, the user may provide input via the fleet management device 204b and/or the user interface 210. The input may comprise, for example, indications of desired underwriting products, user information, safety program parameters and/or actions—such as remedial actions that will be taken (or have been taken) in response to specific types of safety issues or violations. In some embodiments, the insurance provider device 204a may receive and/or process the input to determine safety program compliance, policy pricing and/or discounts, safety program manager performance, etc. According to some embodiments, the user interface 210 may be utilized to provide vehicle and/or driver performance and/or metrics to the user (e.g., based on data from the vehicle telematic devices 202a-n) such as in the form of graphs, charts, and/or predictive and/or virtual modeling.

In some embodiments, the third-party device 208 may comprise an electronic device owned and/or operated by or in association with a third-party (not explicitly shown) such as a telematics data service provider. The third-party device 208 may, for example, comprise a server and/or communications module via which data from the vehicle telematic devices 202a-n is obtained. In some embodiments, such as in the case that the third-party provides analytic services in association with the data from the vehicle telematic devices 202a-n, the third-party device 208 may comprise and/or may provide such analytics via the user interface 210. In some embodiments, the third-party device 208 may route and/or forward the data from the vehicle telematic devices 202a-n (and/or a portion thereof) to the insurance provider device 204a and/or the fleet management device 204b (e.g., via the user interface 210). In some embodiments, the third-party device 208 may provide other insurance product pricing information to the insurance provider device 204a (and/or the fleet management device 204b and/or user interface 210) such as credit scores, risk ratings, demographics, etc.

According to some embodiments, any program code, rules, communications protocols, and/or definitions, modules, objects, and/or any combination thereof that cause and/or facilitate operation of the insurance provider device 204a, the fleet management device 204b, and/or the user interface 210, may be managed, defined, edited, and/or stored via an API program, plug-in, application, module, and/or device (not shown in FIG. 2). The API device may, for example, comprise a specially-programmed API, program, application, and/or other function or procedure that facilitates creation, setup, and/or execution or management of an underwriting and/or underwriting product pricing tool and/or of a safety program management and/or predictive modeling tool.

Turning to FIG. 3, a flow diagram of a method 300 according to some embodiments is shown. In some embodiments, the method 300 may be performed and/or implemented by and/or otherwise associated with one or more specialized and/or computerized processing devices (e.g., the user devices 102a-n, the vehicle telematics devices 202a-n, and/or the controller devices 104, 204a-b, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 300 may be embodied in, facilitated by, and/or otherwise associated with various input mechanisms and/or interfaces such as the interface 210 described with respect to FIG. 2 herein. In some embodiments, the components 302, 304, 305, 306, 308, 310, 312, 314, 316, 318, 320, 322, 324 of the method 300 may be similar in configuration and/or functionality to similarly named and/or numbered components as described herein.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 300 may be illustrative of a process that occurs when a customer requests a product (e.g., an underwriting and/or insurance product) from an underwriter, customer service representative, distributor, underwriting system, etc. According to some embodiments, the method 300 may be illustrative of a process of self-service underwriting product pricing (such as the customer pricing an insurance policy online). In some embodiments, the method 300 may comprise initiating the quote process, at 302. An underwriter and/or customer may, for example, utilize an interface (such as the exemplary interface 210 of FIG. 2) to search for, identify, and/or otherwise determine an existing account. In some embodiments, an account search may comprise an account login and/or associated credential check (e.g., password-protected account login). An account search may be based, in some embodiments, on a customer name, business name, account number, and/or other identification information that is or becomes known or practicable. In some embodiments, a computerized processing device such as a PC or computer server and/or a software program and/or interface may conduct the search and/or may receive information descriptive of the search and/or one or more indications thereof.

According to some embodiments, the initiation of the quote process at 302 may comprise customer detail entry (such as in the case that an existing account is not identified by a search). Any appropriate and/or desired employee, agent, and/or other entity associated with a business (e.g., a customer's business and/or an underwriting business) may, for example, input customer information into a software application and/or an interface (e.g., utilizing a computerized processing device as described herein). Such information, according to some embodiments, may comprise (but is not limited to) customer/business name and/or address, vehicle (e.g., fleet) information, business type, business profitability, revenues, costs, overhead, default rates (e.g., regarding certain products and/or types of products), exposure, taxes, credit ratings and related information, any other financial and/or operational metric that is or becomes desirable, and/or any combination thereof.

In some embodiments, the customer detail/information may comprise qualitative information such as an underwriter's personal assessment of the qualifications of the management team of a customer/customer's company (e.g., as determined through a face-to-face and/or telephonic meeting). In some embodiments, such as in the case that an account search results in an identification of an existing account, the some or all of the customer detail entry may not be required and/or desired (e.g., such information may already be stored in association with the existing account). According to some embodiments, a computerized processing device such as a PC or computer server and/or a software program and/or interface may receive the customer detail entry and/or one or more indications thereof. In some embodiments, the initiation at 302 may comprise location entry. The customer and/or underwriter may, for example, enter information descriptive of one or more locations of the customer and/or the customer's business. According to some embodiments, the initiation at 302 may comprise business classification. In some embodiments, the initiation at 302 may comprise a determination of whether a customer, business, policy, and/or product is eligible (e.g. within the risk appetite of an insurer). In some embodiments, the initiation at 302 may comprise policy (and/or product) type selection.

According to some embodiments, the method 300 may comprise a determination, at 304, as to whether vehicle telematics will be utilized in association with the desired policy/product. An agent, CSR, and/or underwriter may inquire, for example, as to whether a customer desires (and/or will allow) the use of vehicle telematic data (e.g., personal or fleet) in association with the desired policy/product. In some embodiments, information related to and/or descriptive of vehicle telematics may be received (e.g., at 302 and/or 304). Such information may include, for example (but is not limited to), information descriptive of a quantity and/or type of vehicle(s) in a fleet of vehicles and/or information descriptive of vehicle telematics devices utilized by various vehicles (e.g., a percentage of fleet vehicles that utilize vehicle telematic devices and/or certain types and/or configurations thereof). In the case that it is determined at 304 that vehicle telematics will not be utilized, the method 300 may proceed directly to determine whether to accept and/or modify the application/request, at 305.

In accordance with various underwriting and/or business criteria, for example, it may be determined whether, and/or to what extent, insurance coverage (and/or other underwriting products) may be offered to a particular entity. In some embodiments, such as in the case that information associated with the applicant (e.g., the percentage of vehicles utilizing telematic devices, business type, and/or other parameters) is not determined to be acceptable and/or appropriate (in general and/or for a particular type or configuration of underwriting product), the method 300 may continue to reject the application, at 305-1. In some embodiments, data regarding the applicant and/or application may be analyzed (e.g., at 305) to determine one or more conditions that should be assigned to and/or otherwise associated with the requested product/policy. Conditions, requirements, and/or limitations may be flagged (e.g., in a database record) and/or a notification regarding such product/policy attributes may be provided to one or more entities. An electronic notification (such as an e-mail message) may be sent to an underwriter and/or CSR or agent, for example, notifying the entity of the required (and/or desired) policy restrictions, conditions, and/or limitations. In some embodiments, such as in the case that the method 300 is performed subsequent to a policy being issued (and/or product being sold), such as during and/or as a policy review procedure, the determination at 305 may comprise determining a modification to the existing policy (and/or product). Based on information received at 304 (and/or as otherwise described herein), for example, an amount of coverage and/or other policy conditions as originally issued may be altered.

According to some embodiments, such as in the case that it is determined that the application should and/or will be accepted and/or modified (at 305), the method 300 may continue to product pricing, at 306. The product pricing at 306 may, according to some embodiments, comprise policy creation that may, for example, be based on policy type selection, customer detail entry, and/or account searching and/or data (e.g., a number and/or percentage of vehicles utilizing vehicle telematic devices). An underwriting program and/or associated device and/or interface may create a policy number, session, and/or account identifier, log, and/or other record of policy type selection, for example, in reference to the customer and/or underwriter desiring to price the policy or product. In some embodiments, the product pricing at 306 may comprise coverage selection and/or determination. The customer and/or underwriter may select various available coverage levels and/or types for the policy, for example, as desired (e.g., in accordance with any conditions from 305). According to some embodiments, interface options may allow various available coverage parameters to be selected and/or input. In some embodiments, a computerized processing device such as a PC or computer server and/or a software program and/or interface may receive the coverage selection and/or one or more indications thereof.

In some embodiments, the method 300 may comprise providing a quote, at 308. Based on account searching and/or data, customer detail entry, policy type selected, location entry, business classification, eligibility determination, and/or coverage selected, for example, the underwriter and/or distributor may provide to the customer (and/or the customer may otherwise receive) a quote at 308 for one or more underwriting products. In some embodiments, the underwriter may provide a quote at 308 for any number of underwriting products such as a quote for each of a plurality of insurance product types and/or tiers. According to some embodiments, the underwriter may determine, define, generate, and/or otherwise identify the quote at 308. The quote may then, for example, be provided, transmitted, displayed, and/or otherwise output to the customer via any methodology that is or becomes desirable or practicable, at 308. The quote provided at 308 (e.g., by the underwriting entity) may comprise (but is not limited to) one or more of the following: premium/price (which may include a high-risk price and/or a low-risk price), insurance and/or surety capacity (e.g., an aggregate line of credit), collateral requirements, indemnity requirements, international bond restrictions, surety product type restrictions, other risk restrictions/exclusions, and/or financial reporting requirements. According to some embodiments, a computerized processing device such as a PC or computer server and/or a software program and/or interface may receive the rate quote at 308 and/or one or more indications thereof.

According to some embodiments, the method 300 may comprise a product sale, at 310. An underwriter, customer service representative, distributor, and/or sales agent (who may be the same as or different from the underwriter and/or requester of the product), for example, may receive an indication that the customer desires to purchase an underwriting product based on the quote provided at 308. The necessary paperwork and financial arrangements to consummate the sale of the underwriting product may be put in place, according to some embodiments, thus effectuating the sale of the underwriting product to the customer. In some embodiments, the sale at 310 may include post-sale activities, such as receipt of premiums and revision and/or renewal of underwriting product terms or parameters (e.g., in the case that the method 300 and/or portions thereof are conducted as or as part of a review of an existing policy/product). In some embodiments, the customer may initiate and/or conduct the product sale 310, such as in a self-service manner via a website. According to some embodiments, data may be received in associated with the sale at 310, such as data descriptive of a number and/or percentage of vehicles utilizing vehicle telematic devices, and/or vehicle telematic data descriptive of such vehicles.

In some embodiments, such as in the case that it is determined at 304 that vehicle telematics will be utilized (or are desired to be utilized), the method 300 may proceed to conduct risk control engineering at 312. Various methodologies may be utilized, for example, to determine a level of risk associated with the customer (e.g., based on vehicle telematics and/or an extent and/or type of utilization thereof). In some embodiments, the risk control engineering at 312 may comprise a risk control inspection, at 314. Risk control personnel (and/or electronic monitoring) may be utilized, for example, to inspect the customer's current or proposed utilization of vehicle telematics. Types, quantities, and/or configurations of vehicle telematic devices may be reviewed and inspected, for example, and/or safety program procedures and/or personnel may be reviewed. In some embodiments, results of the risk control inspection 314 may be analyzed and/or processed during a risk control evaluation, at 316. During the risk control evaluation 316, for example, a risk control engineer (and/or rules-based program and/or interface tool) may evaluate the details of the customer's utilization (current and/or proposed) of vehicle telematics (e.g., a number and/or percentage of vehicles utilizing vehicle telematic devices) to determine an actual or expected effectiveness of the customer's safety program. Results of the risk control evaluation 316 may then be utilized during the determination of whether to accept and/or modify the application/policy, at 305, and/or during the product pricing at 306. Less desirable and/or effective (actual or predicted) safety programs utilizing vehicle telematics may, for example, result in higher perceived risk and accordingly warrant higher pricing/premiums for the desired product. In some embodiments, an application and/or policy may be declined (e.g., at 305-1) and/or may routed to an appropriate entity, group, and/or business that may be more likely to have an appetite for the particular risk and/or risk level associated with the application and/or policy.

According to some embodiments, the risk control engineering at 312 may also or alternatively comprise a risk control interview at 318. The customer and/or a representative of the customer, such as a safety program manager may, for example, be interviewed (in person and/or via telephone or online—such as via an online chat, meeting, and/or “telepresence” application) to gather data regarding the customer's safety program and/or vehicle telematics usage. The information gathered during the interview at 318 may then be utilized, for example to inform and/or influence the risk control evaluation at 316.

In some embodiments, the risk control engineering at 312 may also or alternatively comprise receiving vehicle telematic data, at 320. Telematic data from one or more vehicle sensors (e.g., the vehicle telematic devices 202a-n of FIG. 2) and/or data obtained from a vehicle telematics service/data provider (and/or from the customer themselves) may, for example, be received by an insurance underwriter and/or risk control engineer. In some embodiments, such as in the case of historic data, the data may be provided (and/or received) via a stored medium such as a DVD, USB memory device, and/or other memory media. In some embodiments, the received data may be analyzed at 322. Vehicle telematic data may be processed, for example, to determine an expected level of risk associated with the customer and/or an estimated effectiveness of the customer's safety program. In the case of a fleet customer, for example, aggregate and/or statistical data regarding the customer's fleet drivers and/or vehicles may be analyzed to determine types and/or frequencies of undesirable driving behaviors. Individual and/or aggregate data may also or alternatively be analyzed to determine how effective the customer's safety program (and/or the administration thereof) has been. Changes in driving behavior (and/or telematic data) that appear to be in response to imposition of remedial measures may be noted, for example, to determine how effective such remedial measures have been (e.g., may be provided via an interface such as the user interface 210 of FIG. 2 herein). In some embodiments, the results of the analyzing of the vehicle telematic data at 322 may be provided to and/or utilized in the risk control evaluation at 316. In some embodiments, such as in the case that an insurance product utilizing telematic data is already in place with the customer, the results of the analyzing of the vehicle telematic data at 322 may be provided directly to and/or may directly influence the determination of whether to accept and/or modify at 305 and/or the product pricing at 306. Effective and/or diligent implementation of a safety program may, for example, allow the customer to earn a discount in premiums.

According to some embodiments, the risk control engineering at 312 may also or alternatively comprise conducting a risk control survey, at 324. The customer may fill out a form or questionnaire such a paper and/or an electronic form or survey, for example, and provide the information to the insurance provider and/or underwriter or other entity. In some embodiments, the survey data may comprise vehicle telematic data and/or representations thereof. The customer may indicate and/or estimate, for example, a number, frequency, and/or percentage of speeding, hard braking, tailgating (e.g., maintaining an insufficient following distance), and/or other safety violations. The customer may also or alternatively provide indications of the customer's safety program procedures, history, and/or effectiveness. In some embodiments, the survey data may be provided to inform and/or affect the analysis at 322, the risk evaluation at 316, the determination of whether to accept and/or modify at 305, and/or the product pricing at 306. In some embodiments, the risk control engineering 312 (and/or any portion thereof) may be conducted before the determination of whether to accept and/or modify at 305, after the determination of whether to accept and/or modify at 305, before the product pricing at 306, after the product pricing at 306, before the providing of the quote at 308, after the providing of the quote at 308, and/or at multiple points within the method 300, as is or becomes desirable and/or practicable. In some embodiments, such as in the case that the method 300 comprises a reevaluation of an existing policy/product, the risk control engineering 312 (and/or any portion thereof) may also or alternatively occur after the product sale at 310 (e.g., after an initial sale).

Turning to FIG. 4, a flow diagram of a method 400 according to some embodiments is shown. In some embodiments, the method 400 may be performed and/or implemented by and/or otherwise associated with one or more specialized and/or computerized processing devices (e.g., the user devices 102a-n, the vehicle telematics devices 202a-n, and/or the controller devices 104, 204a-b, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 400 may be related to and/or comprise a portion of an underwriting process or method such as the methods 300, 500 of FIG. 3 and/or FIG. 5 herein. In some embodiments, the method 400 may be embodied in, facilitated by, and/or otherwise associated with various input mechanisms and/or interfaces such as the example interface 210 described with respect to FIG. 2 herein. In some embodiments, the components 420, 422a-b, 430a-b, 440, 450 may be similar in configuration and/or functionality to similarly named and/or numbered components as described herein.

In some embodiments, the method 400 may be illustrative of a process that provides safety program feedback, guidance, monitoring, and/or evaluation. In some embodiments, the method 400 may comprise receiving vehicle telematic data, at 420. Vehicle telematic data (and/or indications thereof) may be received, for example, from a third-party data provider, from a customer, and/or directly from one or more vehicle telematic devices (e.g., the vehicle telematic devices 202a-n of FIG. 2). The data may be received in any form or manner that is or becomes known or practicable. The data may be received in encoded, compressed, and/or encrypted form, for example, and may be appropriately processed such as by performing one or more decoding, decompression, and/or decryption algorithms or procedures. In some embodiments, the receiving of the vehicle telematic data at 420 may comprise actively obtaining the data, such as by querying, looking up, requesting, identifying, and/or otherwise determining the data.

According to some embodiments, the method 400 may comprise determining risk parameters, at 422a. The vehicle telematic data (or portion thereof) received (and/or otherwise determined) at 420, for example, may be processed to determine, derive, and/or identify risk parameters that may be determined based on the vehicle telematic data. Risk parameters may include (but are not limited to), in some embodiments, speeding, hard braking, hard cornering, tailgating, high engine Revolutions Per Minute (RPM), high oil temperatures, low tire pressures, etc. A risk parameter such as speeding may, for example, be determined, derived, and/or calculated based on underlying vehicle telematic data such as vehicle speed and/or vehicle location (e.g., “speeding” may be defined as the condition where the vehicle speed exceeds a known posted speed limit at a particular location of the vehicle). Similarly, an unsafe tire pressure situation for a vehicle may be determined based on vehicle telematic data indicating tire pressures and known acceptable ranges of tire pressures for the particular vehicle, tire, and/or tire location (e.g., rear tire, left-side tire, or front-tire). One or more risk parameters for one or more drivers, vehicles, and/or combinations of drivers and/or vehicles may be determined at 422a.

In some embodiments, the method 400 may comprise determining safety metrics, at 422b. Based on the vehicle telematic data from 420 and/or based on the risk parameters from 422a, for example, one or more scores, rankings, and/or other metrics may be determined as a quantitative and/or qualitative measure of one or more particular risk parameters (for one or more drivers, vehicles, and/or combinations or subsets thereof). According to some embodiments, a safety metric may comprise a ranking or score for a particular risk parameter and/or a combination of risk parameters for a fleet of vehicles. Vehicle telematic data for each vehicle from a fleet of vehicles may be received and/or determined at 420, for example, and the data may be utilized to calculate and/or determine one or more values representative of whether the vehicles were, at different points in time, speeding (e.g., to varying degrees). The values for the respective speeding risk parameters may be analyzed and/or processed (such as by taking an average thereof, for example) at 422b, to score the fleet based on the individual, aggregate, average, combined, weighted, best, and/or worst risk parameter value(s). In another example, speeding may be considered, along with time of day, location, and/or other risk parameters, to determine the fleet score. The score may, for example, comprise a metric by which different types, sizes, and/or configurations of fleets may be standardized, normalized, and/or compared.

According to some embodiments, the method 400 may comprise providing a risk parameter interface at 430a and/or a safety metric interface at 430b. Based on the respective risk parameters (and/or values thereof) from 422a and/or safety metrics (and/or values thereof) from 422b, for example, an interface such as the interface 210 of FIG. 2 may be provided (e.g., to the customer, to a third-party, such as a safety and/or regulatory entity, and/or to an insurer). In some embodiments, the providing of interfaces at 430a-b may comprise providing a single combined interface such as a GUI interface via an application such as a mobile application (e.g., configured for utilization and/or display on a smart phone), a plug-in application, and/or a web application (e.g., a web browser, Java® Applet™ and/or Adobe® Flash™ script). According to some embodiments, the providing of the interfaces at 430a-b may comprise providing graphical representations of the data (e.g., from 420 and/or 422a-b) and/or of statistical analysis thereof. A provided interface may display to a user, for example, visual representations of changes in vehicle telematic data, risk parameter values, and/or safety metrics over time. The displayed data may be represented in aggregate and/or as a statistical representation (e.g., an average) for an entire fleet (or fleets), and/or may be displayed for each driver, vehicle, and/or combination thereof. A user may utilize the provided interface(s), in some embodiments, to analyze aggregate data to view and/or visualize underlying levels of data (e.g., to derive and/or realize trends and/or other conclusions there from). According to some embodiments, the interfaces may provide data representative of safety program events (such as remedial actions) such that an effectiveness of the safety program and/or the particular type of remedial action or event may be derived and/or visualized. According to some embodiments, an effectiveness of the safety program and/or portions or events thereof may be scored and/or ranked. Any effect of the safety program scoring or ranking may also or alternatively be displayed via the interface(s) such as by showing how and/or why insurance premiums have changed based on the safety program effectiveness, ranking, and/or scoring.

In some embodiments, the method 400 may comprise providing risk control advice, at 440. Based on the scores and/or values of the safety metrics determined at 422b, for example, a customer may be provided with coaching tips, coaching advice, remedial action training or instruction, self-help and/or educational videos, and/or other guidance. The risk control advice may be tailored to specific areas (e.g., safety metrics, risk parameters, and/or vehicle telematic data types) that are determined to be in need of remediation and/or may be customized based on a particular customer's needs and/or preferences. In some embodiments, the advice may be provided via the interface(s) of 430a-b (not explicitly shown in FIG. 4).

According to some embodiments, the method 400 may comprise safety program modeling, at 450. The interface(s) of 430a-b may be utilized, for example, to provide a mechanism via which a customer (and/or other entity) may visualize how changes in vehicle telematic data, risk parameter values, and/or safety metrics may affect other parameters and/or values such as insurance and/or underwriting product pricing (e.g., premiums, surcharges, discounts, coverage limits). In some embodiments, safety program goals may be visualized and/or virtual coaching/remedial actions may be applied to model and/or predict resulting changes in vehicle telematic data, risk parameter values, safety metrics, and/or product pricing. The risk control advice from 440 may be implemented into the safety program modeling at 450, for example, to model how (and/or to what extent) the recommended actions are likely to affect underlying values, parameters, and/or metrics.

Turning to FIG. 5, a flow diagram of a method 500 according to some embodiments is shown. In some embodiments, the method 500 may be performed and/or implemented by and/or otherwise associated with one or more specialized and/or computerized processing devices (e.g., the user devices 102a-n, the vehicle telematics devices 202a-n, and/or the controller devices 104, 204a-b, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the method 500 may be related to and/or comprise a portion of an underwriting and/or safety program management process or method such as the methods 300, 400 of FIG. 3 and/or FIG. 4 herein. In some embodiments, the method 500 may be embodied in, facilitated by, and/or otherwise associated with various input mechanisms and/or interfaces such as the example interface 210 described with respect to FIG. 2 herein. In some embodiments, the components 502, 512, 520, 522, 540, 550, 560, 570, 580, 590 may be similar in configuration and/or functionality to similarly named and/or numbered components as described herein.

In some embodiments, the method 500 may be illustrative of a process that provides underwriting product pricing and/or safety program feedback, guidance, monitoring, and/or evaluation. In some embodiments, the method 500 may comprise receiving data, at 520. The data may be received, for example, by a computerized processing device such as a controller, server, PC, and/or mobile device, as described herein. In some embodiments, the data may be received by an insurance entity, an insurance product consumer (e.g., a client and/or customer of the insurance company), and/or a third-party. The data may be received from one or more of a variety of sources (local sources, remote sources, and/or any combination thereof). Data may be transmitted from a user device to a server, for example, and/or from a server to a user device. As depicted in FIG. 5, the data may comprise any one or combination of various data types that may be practicable and/or desired (e.g., for utilization in product underwriting and/or pricing and/or for utilization in safety program management and/or evaluation).

According to some embodiments, the data received at 520 may include (but need not be limited to) vehicle telematic data 520-1, recidivism data 520-2, potential coaching impact data 520-3, “coachability” data 520-4, coaching need data 520-5, driving behavior data 520-6, and/or demographic data 520-7. In some embodiments, the vehicle telematic data 520-1 may be received (and/or retrieved) from one or more vehicle telematic devices such as the vehicle telematic devices 202a-n of FIG. 2 herein. The vehicle telematic data 520-1 may, for example, comprise data descriptive of various vehicle and/or driver parameters such as velocity, acceleration (axial and/or lateral), driver breathing and/or heart rate, driver eye movement data, engine and/or motor data, tire pressure values, time of day, vehicle location, etc. According to some embodiments, the recidivism data 520-2 may include data regarding workers compensation claims and/or statistics regarding a particular customer and/or regarding a type and/or classification of customer. In some embodiments, the potential coaching impact data 520-3 may comprise data descriptive of a magnitude by which driver and/or vehicle telematic, risk, and/or safety data and/or trends may be affected by safety program coaching. Corrective action taken with respect to a vehicle that has high oil temperatures, for example, may not have a comparably large impact on safety metrics (e.g., a damaged engine may impact costs much more than safety), while corrective action with respect to low tire pressures may have a comparably large impact on safety metrics (low tire pressures are a leading contributor to vehicle accidents and accordingly have high relevance to safety concerns).

In some embodiments, the “coachability” data 520-4 may comprise data indicative of how likely any corrective action may be at actually affecting an underlying safety issue. It may be determined, for example, that certain types of behaviors such as hard cornering are not easily corrected via any available measure, while other behaviors such as wearing a seat belt are relatively easily coached into correction. In some embodiments, metrics such as “coachability” may be expressed as values, ranges, thresholds, qualitative descriptors, and/or any combination thereof (e.g., a Boolean operator—where one (1) would indicate an acceptable level of “coachability” and where zero (0) would indicate an unacceptable level of “coachability”).

According to some embodiments, the coaching need data 520-5 may comprise data descriptive of how important it is determined that corrective action may be. Based on risk parameter values and/or safety metrics (e.g., from 422a-b of FIG. 4), for example, it may be determined that one or more thresholds requiring various levels of coaching and/or other corrective action may not have been reached. Minor deviations in speed (e.g., a few miles per hour (mph) over a speed limit) may not be considered to require intervention, for example, and/or different levels, magnitudes, and/or types of intervention (e.g., coaching) may be warranted based on different magnitudes and/or frequencies of speeding events.

In some embodiments, the driving behavior data 520-6 may comprise data descriptive of various safety metrics, issues, categories, and/or concerns. As depicted, for example, the driving behavior data 520-6 may comprises data indicative of any or all of speeding, hard braking, hard cornering, tailgating, and/or other safety metrics. In some embodiments, the driving behavior data 520-6 may be received from a vehicle telematic device and/or derived from the vehicle telematic data 520-1. In some embodiments, the driving behavior data 520-6 (and/or the vehicle telematic data 520-1) may be utilized to inform, influence, calculate, derive, and/or define the coaching need data 520-5. Driving behavior data 520-6 indicative of a “high” level of speeding (e.g., more than twenty miles per hour (20 mph) over a posted speed limit) may, for example, trigger an indication that coaching and/or other corrective action is warranted. An indication of the determined need for coaching and/or other action may then be stored in (and/or as) the coaching need data 520-5.

According to some embodiments, the demographic data 520-7 may comprise data descriptive of one or more drivers (or other employees, such as mechanics) and/or one or more vehicles. As depicted, for example, the demographic data 520-7 may be descriptive of age, gender, occupation, location, and/or other demographic indicators. It may be desirable, for example, to know the age of a driver, as certain driving behaviors and/or safety issues may be more or less prevalent in certain age groups. Similarly, vehicle type, class, and/or maintenance records may be telling with respect to mechanically-induced accident likelihood, likelihood of theft, and/or likelihood of extensive damage in an accident (a transit bus is less likely to suffer extensive damage in low speed accidents, while passenger vehicles are much more likely to receive extensive damage in such accidents).

In some embodiments, the method 500 may comprise data analysis at 522. Any or all of the data received at 520, for example, may be identified, determined, received, retrieved, queried, and/or utilized in one or more formulas, calculations, rules-based algorithms, and/or otherwise processed as desired to effectuate embodiments described herein. Data from 520 may be utilized, for example, to facilitate and/or conduct a quote process 502, risk control engineering 512, providing of risk control advice 540, and/or safety program modeling 550. In some embodiments, data received at 520 may be utilized at 522 to calculate, define, and/or produce other data. As shown by the dotted lines in FIG. 5, for example, any or all of the recidivism data 520-2, the potential coaching impact data 520-3, the coachability data 520-4, the coaching need data 520-5, the driving behavior data 520-6, and/or the demographic data 520-7 (and/or any portions of any such data thereof) may be determined at 522. The vehicle telematic data 520-1 may, for example, be utilized to determine driving behavior data 520-6 such as tailgating and/or the demographic data 520-7 in combination with the vehicle telematic data 520-1 may be utilized to determine coachability data 520-4. In some embodiments, some of the data received at 520 may be provided by third-party sources—such as some or all of the demographic data 520-7 and/or the vehicle telematic data 520-1. Such third-party data may be combined and/or analyzed with other data (such as local data) to generate other data and/or metrics, as described herein.

According to some embodiments, the method 500 may comprise providing price adjustments, at 560. In some embodiments, pricing adjustments may be based on the data analysis at 522. In relation to and/or as part of the quote process 502 and/or the risk control engineering 512, the price adjustments may comprise quotes for product premiums, surcharges, and/or discounts. In the case that the quote process 502 and/or the risk control engineering 512 are conducted with respect to an existing policy and/or product, the price adjustments may comprise a surcharge, discount, and/or other change in an existing premium. The method 500 may comprise a portion of the method 300 of FIG. 3, for example, via which a quote for an underwriting product is provided and/or obtained. In relation to and/or as part of the risk control advice 540 and/or the safety program modeling 550, the price adjustments may comprise actual and/or predicted alterations to a product premium. The method 500 may comprise a portion of the method 400 of FIG. 4, for example, via which changes based on safety program actions may be visualized (e.g., via the interface(s) of 430a-b of FIG. 4) with respect to their effect (actual or anticipated) on product pricing.

In some embodiments, the method 500 may comprise suggesting remedial action at 570. In some embodiments, suggestions may be based on the data analysis at 522. As part of a risk control and/or safety program management process, for example, it may be determined at 522 that remedial and/or corrective actions should be taken to improve a safety program and/or drivers or vehicles subject thereto. In some embodiments, the suggested action at 570 may comprise providing one or more coaching tips 570-1. Based on the data analysis at 522, for example, it may be determined that certain drivers require and/or should be given particular instructions and/or training. Appropriate suggestions, guidance, and/or recommendations may then be provided as coaching tips 570-1 at 570. In some embodiments, various remedial actions 570-2 may be suggested at 570. As depicted in FIG. 5, for example, it may be suggested that a driver and/or vehicle be taken off the road, have a current and/or typical route altered, have driving times altered, that a particular driver be switched to a different vehicle and/or vehicle type, and/or that other actions be taken.

According to some embodiments, remedial action may be taken by an insured (e.g., a personal and/or business or commercial insurance customer; and/or detected, e.g., by an insurer), at 580. In some embodiments, the remedial action at 580 may be conducted in response to the suggestion of remedial action at 570. In some embodiments, the remedial action at 580 may be conducted in the absence of and/or without direction from the suggestion at 570. A safety program manager may, for example, take into account the suggestion(s) at 570 and may conduct and/or implement the action at 580 in accordance therewith. Or the safety program manager may implement and/or conduct the action at 580 at the safety manager's own volition and/or in accordance with different suggestions and/or reasoning than provided at 570. While a suggested response to a tailgating driver may be to switch vehicle or change the time of day that the driver is on the road, for example, the safety manager overseeing the driver may instead provide tips or other coaching relating to better estimating a safe following distance (e.g., an action which the safety manager has learned or may reasonably conclude reduces tailgating for that particular driver). In some embodiments, an indication of the remedial action may be received at 580. A fleet safety manager may implement various safety program actions, for example, and indications of the taken actions may be provided to an insurance provider.

In some embodiments, the effectiveness of a safety program and/or action (e.g., the action at 580) may be evaluated, at 590. In some embodiments, the evaluation at 590 may be triggered by and/or conducted in response to the action (and/or detection thereof) at 580. In some embodiments, the evaluation may be scheduled (e.g., every minute, hour, day, week, etc.) and/or may occur irrespective of any action at 580. Further and/or continued data analysis 522 may be conducted, according to some embodiments, to determine how any action taken has actually affected any data, parameters, and/or metrics. In the case that the original vehicle telematic data 520-1 received at 520 was determined to indicate (e.g., at 522) an inappropriate level of speeding for a fleet of vehicles, for example, it may have been suggested at 570 that the drivers in the fleet be given a safety training seminar. Upon an indication at 580 that an action has been taken to address the problem of fleet speeding, the effectiveness of the action may be evaluated at 590 by receiving new data at 520, and performing a new (and/or continued) analysis at 522. According to some embodiments, such evaluation may take place over a particular time period such as a week, bi-weekly period, month, etc., as is appropriate (e.g., given the type of data analyzed and/or the quantity of such data available) desired. New vehicle telematic data 520-1 received at 520 may, after and/or via analysis at 522, for example, show that speeding in the fleet has decreased since the action was taken at 580. In the case that it is determined that the decrease is likely due to the action (e.g., and not some other factor), it may be concluded that the safety program successfully addressed the issue. Information regarding the effectiveness (and/or different effectiveness levels and/or magnitudes) of the safety program may then be utilized, for example, in the quote process 502, risk control engineering 512, risk control advice 540, and/or safety program modeling 550.

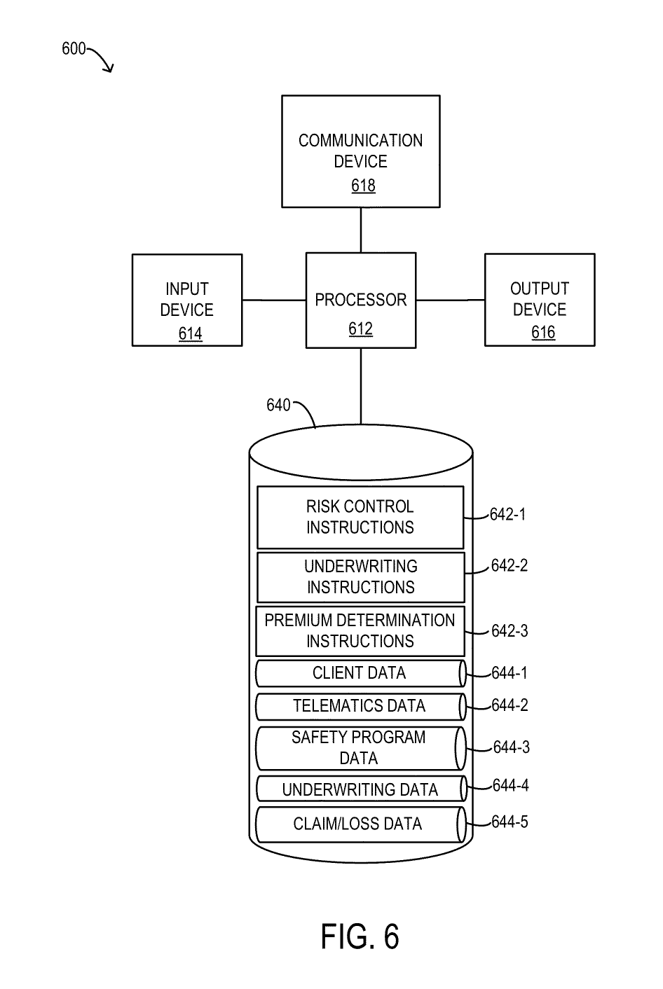

Turning to FIG. 6, a block diagram of an apparatus 600 according to some embodiments is shown. In some embodiments, the apparatus 600 may be similar in configuration and/or functionality to user devices 102a-n, the vehicle telematics devices 202a-n, and/or the controller devices 104, 204a-b, of FIG. 1 and/or FIG. 2 herein. The apparatus 600 may, for example, execute, process, facilitate, and/or otherwise be associated with the methods 300, 400, 500 of FIG. 3, FIG. 4, and/or FIG. 5, and/or may output or provide the interface 210 of FIG. 2 herein. In some embodiments, the apparatus 600 may comprise an electronic processor 612, an input device 614, an output device 616, a communication device 618, and/or a memory device 640. Fewer or more components 612, 614, 616, 618, 640 and/or various configurations of the components 612, 614, 616, 618, 640 may be included in the system 600 without deviating from the scope of embodiments described herein.

According to some embodiments, the electronic processor 612 may be or include any type, quantity, and/or configuration of electronic and/or computerized processor that is or becomes known. The electronic processor 612 may comprise, for example, an Intel® IXP 2800 network processor or an Intel® XEON™ Processor coupled with an Intel® E7501 chipset. In some embodiments, the electronic processor 612 may comprise multiple inter-connected processors, microprocessors, and/or micro-engines. According to some embodiments, the electronic processor 612 (and/or the apparatus 600 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 600 comprises a server such as a blade server, necessary power may be supplied via a standard AC outlet, power strip, surge protector, and/or Uninterruptible Power Supply (UPS) device.

In some embodiments, the input device 614 and/or the output device 616 are communicatively coupled to the electronic processor 612 (e.g., via wired and/or wireless connections, traces, and/or pathways) and they may generally comprise any types or configurations of input and output components and/or devices that are or become known, respectively. The input device 614 may comprise, for example, a keyboard that allows an operator of the apparatus 600 to interface with the apparatus 600 (e.g., an underwriter, such as to implement and/or interact with embodiments herein to underwrite, quote, and/or sell underwriting products). The output device 616 may, according to some embodiments, comprise a display screen and/or other practicable output component and/or device. The output device 616 may, for example, provide safety program guidance and/or underwriting quotes (e.g., via a website and/or via a computer workstation). According to some embodiments, the input device 614 and/or the output device 616 may comprise and/or be embodied in a single device such as a touch-screen monitor.

In some embodiments, the communication device 618 may comprise any type or configuration of communication device that is or becomes known or practicable. The communication device 618 may, for example, comprise a Network Interface Card (NIC), a telephonic device, a cellular network device, a router, a hub, a modem, and/or a communications port or cable. In some embodiments, the communication device 618 may be coupled to provide data to a customer device, such as in the case that the apparatus 600 is utilized to provide underwriting product quotations and/or sales. According to some embodiments, the communication device 618 may also or alternatively be coupled to the electronic processor 612. In some embodiments, the communication device 618 may comprise an IR, RF, Bluetooth™, and/or Wi-Fi® network device coupled to facilitate communications between the electronic processor 612 and another device (such as a customer device and/or a third-party device).

The memory device 640 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of risk control instructions 642-1, underwriting instructions 642-2, and/or premium determination instructions 642-3. In some embodiments, the risk control instructions 642-1, underwriting instructions 642-2, and/or premium determination instructions 642-3 may be utilized by the electronic processor 612 to provide output information via the output device 616 and/or the communication device 618 (e.g., the providing of the product pricing at 306 of the method 300 of FIG. 3 and/or the providing of the interface(s) 430a-b of the method 400 of FIG. 4).

According to some embodiments, the risk control instructions 642-1 may be operable to cause the electronic processor 612 to access client data 644-1, telematics data 644-2, safety program data 644-3, underwriting data 644-4, and/or claim/loss data 644-5 (e.g., in accordance with the methods 300, 400, 500 of FIG. 3, FIG. 4, and/or FIG. 5 herein). Client data 644-1, telematics data 644-2, safety program data 644-3, underwriting data 644-4, and/or claim/loss data 644-5 received via the input device 614 and/or the communication device 618 may, for example, be analyzed, sorted, filtered, decoded, decompressed, ranked, scored, plotted, and/or otherwise processed by the electronic processor 612 in accordance with the risk control instructions 642-1. In some embodiments, client data 644-1, telematics data 644-2, safety program data 644-3, underwriting data 644-4, and/or claim/loss data 644-5 may be fed by the electronic processor 612 through one or more mathematical and/or statistical formulas, rule sets, policies, and/or models in accordance with the risk control instructions 642-1 to determine a safety program evaluation (e.g., the risk control evaluation 316 of FIG. 3) and/or safety program guidance (e.g., the risk control advice 440 and/or the safety program modeling 450 of FIG. 4) as described herein.

According to some embodiments, the underwriting instructions 642-2 may be operable to cause the electronic processor 612 to access the client data 644-1, telematics data 644-2, safety program data 644-3, underwriting data 644-4, and/or claim/loss data 644-5 (e.g., in accordance with the methods 300, 400, 500 of FIG. 3, FIG. 4, and/or FIG. 5 herein). Client data 644-1, telematics data 644-2, safety program data 644-3, underwriting data 644-4, and/or claim/loss data 644-5 received via the input device 614 and/or the communication device 618 may, for example, be analyzed, sorted, filtered, decoded, decompressed, ranked, scored, plotted, and/or otherwise processed by the electronic processor 612 in accordance with the underwriting instructions 642-2. In some embodiments, client data 644-1, telematics data 644-2, safety program data 644-3, underwriting data 644-4, and/or claim/loss data 644-5 may be fed by the electronic processor 612 through one or more mathematical and/or statistical formulas, rule sets, policies, and/or models in accordance with the underwriting instructions 642-2 to determine one or more underwriting questions, criteria, and/or requirements that may then be utilized to facilitate product underwriting (e.g., the risk control engineering 312 of FIG. 3 and/or the method 300 of FIG. 3) as described herein.

According to some embodiments, the premium determination instructions 642-3 may be operable to cause the electronic processor 612 to access client data 644-1, telematics data 644-2, safety program data 644-3, underwriting data 644-4, and/or claim/loss data 644-5 (e.g., in accordance with the methods 300, 400, 500 of FIG. 3, FIG. 4, and/or FIG. 5 herein). Client data 644-1, telematics data 644-2, safety program data 644-3, underwriting data 644-4, and/or claim/loss data 644-5 received via the input device 614 and/or the communication device 618 may, for example, be analyzed, sorted, filtered, decoded, decompressed, ranked, scored, plotted, and/or otherwise processed by the electronic processor 612 in accordance with the premium determination instructions 642-3 In some embodiments, client data 644-1, telematics data 644-2, safety program data 644-3, underwriting data 644-4, and/or claim/loss data 644-5 may be fed by the electronic processor 612 through one or more mathematical and/or statistical formulas, rule sets, policies, and/or models in accordance with the premium determination instructions 6742-3 to determine a quote (e.g., at 306 of the method 300 of FIG. 3) that may then be utilized to facilitate product underwriting and/or sales as described herein.

In some embodiments, the memory device 640 may store the claim/loss data 644-5. The claim/loss data 644-5 may, for example, comprise data obtained from determining loss information such as may be based on one or more loss and/or default events associated with a customer and/or product. The claim/loss data 644-5 may, according to some embodiments, be utilized to update, modify, and/or otherwise influence or affect the various calculations and/or processes described herein. The input device 614 and/or the communication device 618 may receive the claim/loss data 644-5, which may be stored (as depicted in FIG. 6) by the memory device 640 and/or which may be processed by the electronic processor 612 in accordance with stored instructions (not explicitly shown in FIG. 6), such as to modify one or more of the risk control instructions 642-1, underwriting instructions 642-2, and/or premium determination instructions 642-3.

According to some embodiments, the apparatus 600 may generally function as a computer terminal and/or server of an insurance and/or surety underwriting company, for example, which is utilized to process various insurance, surety, and/or other underwriting product applications. In some embodiments, the apparatus 600 may comprise a web server and/or other portal (e.g., an Interactive Voice Response Unit (IVRU)) that provides underwriting and/or product pricing information to customers and/or third-parties. According to some embodiments, the apparatus 600 may comprise and/or provide an interface via which users may visualize, model, and/or otherwise manage safety program information.

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 600. According to some embodiments, the memory device 640 may be incorporated into and/or otherwise coupled to the apparatus 600 (e.g., as shown) or may simply be accessible to the apparatus 600 (e.g., externally located and/or situated).

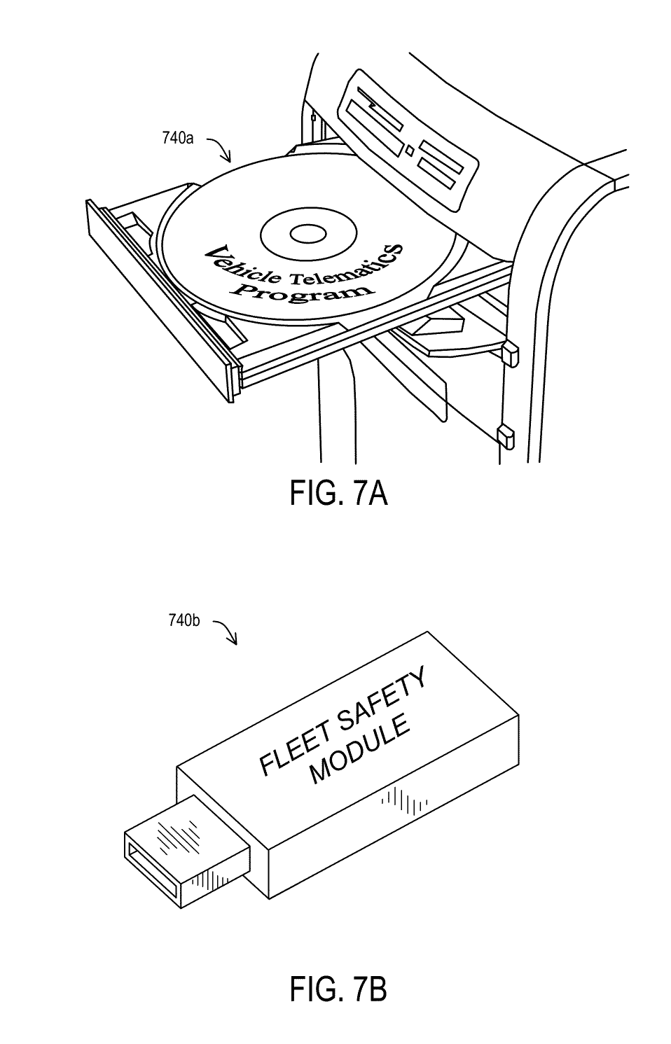

Referring to FIG. 7A and FIG. 7B, perspective diagrams of exemplary data storage devices 740a-b according to some embodiments are shown. The data storage devices 740a-b may, for example, be utilized to store instructions and/or data such as the risk control instructions 642-1, underwriting instructions 642-2, and/or premium determination instructions 642-3, each of which is described in reference to FIG. 6 herein. In some embodiments, instructions stored on the data storage devices 740a-b may, when executed by a processor (such as the electronic processor 612 of FIG. 6), cause the implementation of and/or facilitate any of the various methods 300, 400, 500 of FIG. 3, FIG. 4, and/or FIG. 5, described herein. The data storage devices 740a-b may also or alternatively store data such as the client data 644-1, telematics data 644-2, safety program data 644-3, underwriting data 644-4, and/or claim/loss data 644-5, all as described with reference to FIG. 6 herein.

According to some embodiments, the first data storage device 740a may comprise a CD, CD-ROM, DVD, Blu-Ray™ Disc, and/or other type of optically-encoded disk and/or other computer-readable storage medium that is or becomes know or practicable. In some embodiments, the second data storage device 840b may comprise a USB keyfob, dongle, and/or other type of flash memory data storage device that is or becomes know or practicable. The data storage devices 740a-b may generally store program instructions, code, and/or modules that, when executed by an electronic and/or computerized processing device cause a particular machine to function in accordance with embodiments described herein. In some embodiments, the data storage devices 740a-b depicted in FIG. 7A and FIG. 7B are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

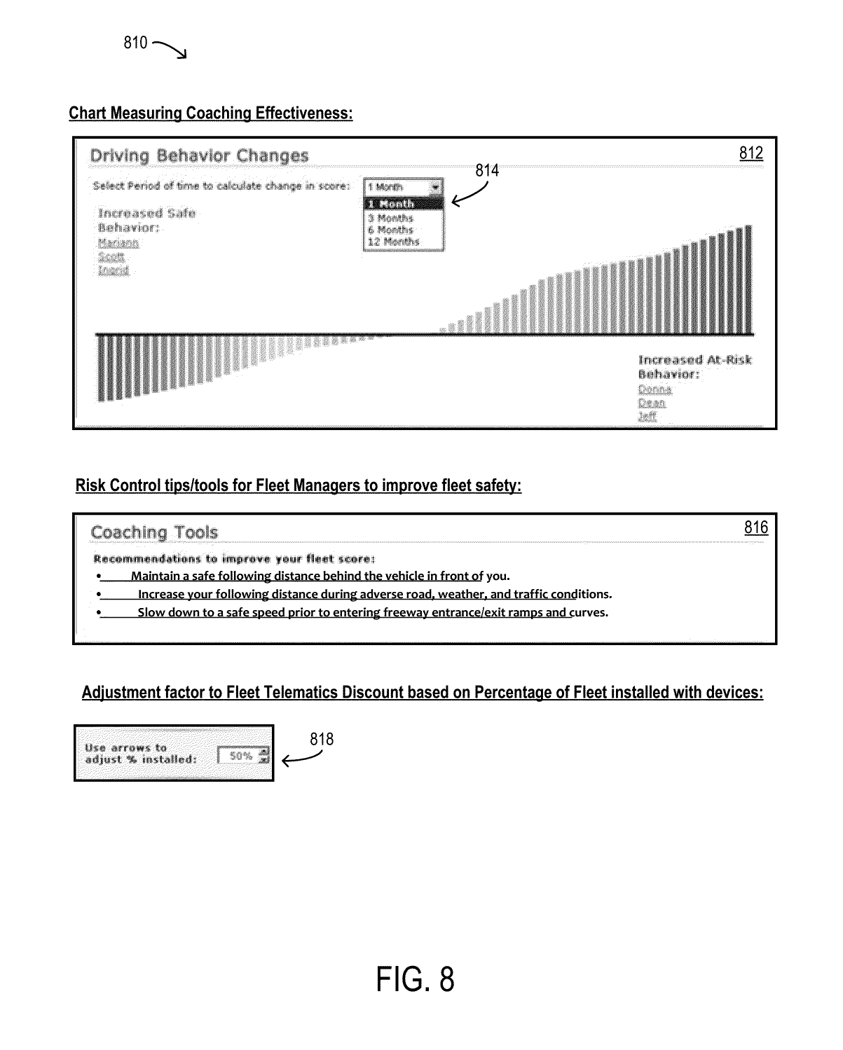

Turning now to FIG. 8, an exemplary interface 810 according to some embodiments is shown. In some embodiments, the interface 810 may comprise a web page, web form, database entry form, API, spreadsheet, table, and/or application or other GUI via which a user, such as an underwriter or a client, for example, may enter data and/or view to conduct and/or facilitate insurance product pricing and safety program management. The interface 810 may, for example, comprise a front-end of an underwriting program and/or platform programmed and/or otherwise configured to execute, conduct, and/or facilitate any of the various methods 300, 400, 500 of FIG. 3, FIG. 4, and/or FIG. 5 and/or portions or combinations thereof described herein. In some embodiments, the interface 810 may be output via a computerized device such as one or more of the user devices 102a-n, 202a-n, the controller device 104, and/or the devices 204a-b and 208, of FIG. 1 and/or FIG. 2 herein. According to some embodiments, the interface 810 may be similar in configuration and/or functionality to the user interface 210, the risk parameter interface 430, and/or the safety metric interface 430b described in conjunction with FIG. 2 and FIG. 4 herein. Components of the interface 810 may, for example, be similar in configuration and/or functionality to any similarly-named and/or numbered components described herein.

According to some embodiments, the interface 810 may comprise a behavior change window 812, which depicts the change in risk for all individual drivers in a group of drivers (e.g., a fleet). The driver information is shown as a continuum of drivers who have lowered their risk (at the left of the graph, below the horizontal axis) through drivers who have increased their risk (at the right of the graph, above the horizontal axis) over a period of time. In the illustrated interface 810, the time period may be selected from the drop down box 814 in the center of the graph. In some embodiments, the bars may be color coded, such as, for example, green bars to indicate lowered risk and red bars to indicate increased risk. Other color schemes may also be used. In one example, a graph showing the majority of bars below the horizontal axis represents a fleet that has improved its overall performance, whereas a graph showing the majority of bars above the horizontal axis represents a fleet whose performance has decreased.

According to other embodiments, the interface 810 may also comprise a coaching tips window 816. The coaching tips may by similar to and/or provided in association with the providing of risk control advice 440 and/or the coaching tips 570-1 of methods 400 and 500 in FIG. 4 and FIG. 5.

According to further embodiments, the interface 810 may comprise an installation window 818, indicating the percentage of the fleet in which telematics devices are installed. The installation window 818 may be used to set and/or determine the number and/or percentage of vehicles utilizing vehicle telematic devices in a fleet. As discussed above, that value may be used in association with product pricing 306 in association with the method 300 shown in FIG. 3.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method of calculating an insurance premium based upon an analysis of an effectiveness of a vehicle safety program implemented with respect to a fleet of vehicles, said analysis being at least partially based on data provided by one or more remote telematics data sensor devices, comprising:
receiving, by a computer server, first data provided by the one or more remote telematics data sensor devices, said first data being descriptive of first values of one or more physical attributes associated with use of the vehicles in the fleet of vehicles by a plurality of drivers for the fleet of vehicles;
receiving, by the computer server and from a fleet management device, information descriptive of a vehicle safety program for the fleet of vehicles, the information being descriptive of a first remedial action defined by the vehicle safety program;
receiving, by the computer server and after the receiving of the information descriptive of the vehicle safety program for the fleet of vehicles, second data provided by the one or more remote telematics data sensor devices, said second data being descriptive of second values of the one or more physical attributes associated with use of the vehicles in the fleet of vehicles by a plurality of drivers for the fleet of vehicles;
determining, by the computer server and in response to the receiving of the second data, and based on a comparison of the first data and the second data, an effect of the first remedial action;
determining, by the computer server and based on the effect of the first remedial action, a premium for an insurance product covering the fleet of vehicles; and
transmitting, by the server device and to the fleet management device, an indication of the determined premium.

2. The method of claim 1, wherein the information descriptive of the vehicle safety program for the fleet of vehicles comprises at least one of: (i) recidivism data; (ii) potential coaching impact data; (iii) coachability data; (iv) coaching need data; (v) driving behavior data; and (vi) demographic data.

3. The method of claim 1, further comprising:
providing, by the computer server and based on at least one of the information descriptive of the vehicle safety program for the fleet of vehicles and the effect of the first remedial action, a suggested action.

4. The method of claim 3, wherein the suggested action comprises at least one of a coaching tip and a remedial action.

5. The method of claim 4, wherein the suggested action comprises the remedial action and the remedial action comprises at least one of: (i) taking a driver of the fleet of vehicles or a vehicle of the fleet of vehicles off the road; (ii) changing a route traveled by a driver of the fleet of vehicles or a vehicle of the fleet of vehicles; (iii) changing a vehicle of the fleet of vehicles driven by a driver of the fleet of vehicles; and (iv) changing a time during which a driver of the fleet of vehicles drives.

6. The method of claim 1, wherein the first remedial action comprises at least one of: (i) taking a driver of the fleet of vehicles or a vehicle of the fleet of vehicles off the road; (ii) changing a route traveled by a driver of the fleet of vehicles or a vehicle of the fleet of vehicles; (iii) changing a vehicle of the fleet of vehicles driven by a driver of the fleet of vehicles; and (iv) changing a time during which a driver of the fleet of vehicles drives.

7. The method of claim 1, wherein the second data is received after the vehicle safety program is implemented in the fleet of vehicles.

8. A system for calculating an insurance premium based upon an analysis of an effectiveness of a vehicle safety program implemented with respect to a fleet of vehicles, said analysis being at least partially based on data provided by one or more remote telematics data sensor devices, comprising:
a computerized processing device; and
a memory device in communication with the computerized processing device and storing specially-programmed instructions that when executed by the computerized processing device result in:
receiving first data provided by the one or more remote telematics data sensor devices, said first data being descriptive of first values of one or more physical attributes associated with use of the vehicles in the fleet of vehicles by a plurality of drivers for the fleet of vehicles;
receiving, from a fleet management device, information descriptive of a vehicle safety program for the fleet of vehicles, the information being descriptive of a first remedial action defined by the vehicle safety program;
receiving, after the receiving of the information descriptive of the vehicle safety program for the fleet of vehicles, second data provided by the one or more remote telematics data sensor devices, said second data being descriptive of second values of the one or more physical attributes associated with use of the vehicles in the fleet of vehicles by a plurality of drivers for the fleet of vehicles;
determining, in response to the receiving of the second data, and based on a comparison of the first data and the second data, an effect of the first remedial action;
determining, based on the effect of the first remedial action, a premium for an insurance product covering the fleet of vehicles; and
transmitting, to the fleet management device, an indication of the determined premium.

9. The system of claim 8, wherein the information descriptive of the vehicle safety program for the fleet of vehicles comprises at least one of: (i) recidivism data; (ii) potential coaching impact data; (iii) coachability data; (iv) coaching need data; (v) driving behavior data; and (vi) demographic data.

10. The system of claim 8, wherein the specially-programmed instructions, when executed by the computerized processing device, further result in:
providing, based on at least one of the information descriptive of the vehicle safety program for the fleet of vehicles and the effect of the first remedial action, a suggested action.

11. The system of claim 10, wherein the suggested action comprises at least one of a coaching tip and a remedial action.

12. The system of claim 11, wherein the suggested action comprises the remedial action and the remedial action comprises at least one of: (i) taking a driver of the fleet of vehicles or a vehicle of the fleet of vehicles off the road; (ii) changing a route traveled by a driver of the fleet of vehicles or a vehicle of the fleet of vehicles; (iii) changing a vehicle of the fleet of vehicles driven by a driver of the fleet of vehicles; and (iv) changing a time during which a driver of the fleet of vehicles drives.

13. The system of claim 8, wherein the first remedial action comprises at least one of: (i) taking a driver of the fleet of vehicles or a vehicle of the fleet of vehicles off the road; (ii) changing a route traveled by a driver of the fleet of vehicles or a vehicle of the fleet of vehicles; (iii) changing a vehicle of the fleet of vehicles driven by a driver of the fleet of vehicles; and (iv) changing a time during which a driver of the fleet of vehicles drives.

14. The system of claim 8, wherein the second data is received after the vehicle safety program is implemented in the fleet of vehicles.

15. The system of claim 8, further comprising:
the one or more remote telematics data sensor devices in communication with the at least one of the computerized processing device and the memory device.

16. The system of claim 8, further comprising:
the fleet management device in communication with the at least one of the computerized processing device and the memory device.

17. The system of claim 16, further comprising:
the one or more remote telematics data sensor devices in communication with the at least one of the computerized processing device, the memory device, and the fleet management device.
